(19) United States
(12) Patent Application Publication
(10) Pub. No.: US 2008/0225631 A1
(43) Pub. Date: Sep. 18, 2008

(54) CONTINUOUS FEED CEMENT MIXER

(76) Inventor: Stephen Ferris, Marlborough, MA (US)

Correspondence Address: LAW OFFICE OF BRETT N. DORNY, 386 WEST MAIN STREET, SUITE 12A, NORTHBOROUGH, MA, 01532, US

(21) Appl. No.: 11/685,349

(22) Filed: Mar. 13, 2007

(51) Int. Cl. B28C 7/12

(52) U.S. Cl. 366/16; 366/26; 366/30

(57) ABSTRACT

A continuous feed mixer for cement or other mixtures includes a mixing tube which is inclined downward from a feed end to a mixing end. Cement solids are deposited at the feed end. Water is introduced at various locations along the length of the mixing tube to provide a proper proportion of solids and water. The mixing tube is rotated to provide the desired mixing process. A scraper is positioned within the mixing tube to remove material from an inner wall of the mixing tube during the mixing process.

### BACKGROUND OF THE INVENTION

1. Field of the Invention

The present invention relates to cement mixers. More particularly, it relates to a continuous feed cement mixer.

2. Discussion of Related Art

A variety of devices have been developed over time to combine powered or aggregate solids and a liquid. Such devices are used for mixing concrete and cement. Similar devices are used for mixing raw materials in manufacturing and preparing batter and dough for baking. Generally, such mixing devices fall within two categories.

The first type of mixer is a batch mixer. In a batch mixer, the solids are deposited into a receptacle or mixing chamber. Agitators within the receptacle rotate to mix the ingredients. The liquid is added until the mixture reaches the desired consistency. Once the mixture is completely formed, it is removed through the same opening through which the ingredients were added. The agitators, receptacle, or both can rotate in order to mix the ingredients.

The second type of mixer is a continuous feed mixer. In a continuous feed mixer, the solids are deposited in one end of an elongated receptacle and the mixed ingredients exit from another end. The liquid is added along the length of the receptacle. Typically, a screw auger rotates within the receptacle to move the ingredients along its length and to mix the ingredients during the movement process. Different types of augers are used to improve the mixing process.

There are many difficulties with both types of mixers. The amount of material to be mixed in a batch mixer cannot be easily adjusted. The user must know the final amount of material desired before starting the mixing process. Additionally, small batches are difficult to mix with consistent results. Although continuous feed mixers can be more easily used for variable amounts of material, they also do not function well for small amounts. Both types of mixer are difficult to clean after the mixing process is complete. The number of parts and awkward shapes necessary to achieve the mixing process create multiple parts with hard to clean locations.

### SUMMARY OF THE INVENTION

The present invention includes a continuous feed mixer without an auger. According to one aspect of the invention, the continuous feed mixer includes a rotating tube which is angled downwardly from a feed end to a discharge end. Gravity is used mix the ingredients and move them along the tube. Liquid is added to the mixer along its length to achieve the desired consistency of the mixture. According to another aspect of the invention, an elongated scraper is positioned along the length of the rotating tube to scrape the interior surface. The scraper is fixedly positioned at the highest point along the tube.

According to another aspect of the invention, solids are fed into the feed end of the mixer tube from a silo using an adjustable feeder. The adjustable feeder is an adjustable speed conveyor or screw type feeder. According to another aspect of the invention, a controller is connected to the mixer to control the mixing process. The controller is used to adjust the rotation speed of the mixer and the amount of liquid added at each point along the length of the tube. According to another aspect of the invention, the angle of the tube is adjustable to control the rate at which the mixture moves through the tube. According to another aspect of the invention, the tube is cleaned by injecting water or a cleaning solution into the tube without feeding solids.

### BRIEF DESCRIPTION OF THE DRAWINGS

FIG. 1 is a side view of a continuous feed mixer according to an embodiment of the present invention.

FIG. 2 is a cross sectional view of a mixing tube of the continuous feed mixer of FIG. 1.

### DETAILED DESCRIPTION

A continuous feed mixer according to an embodiment of the present invention provides a simplified structure which is easy to control and to clean for different amounts of ingredients. The mixer is described in connection with mixing of cement. However, it could be used for any mixture of a powered solid or aggregate with a liquid. It could be used for mixing concrete or mortar in the building industry. It could also be used for industrial processes or for food production processes.

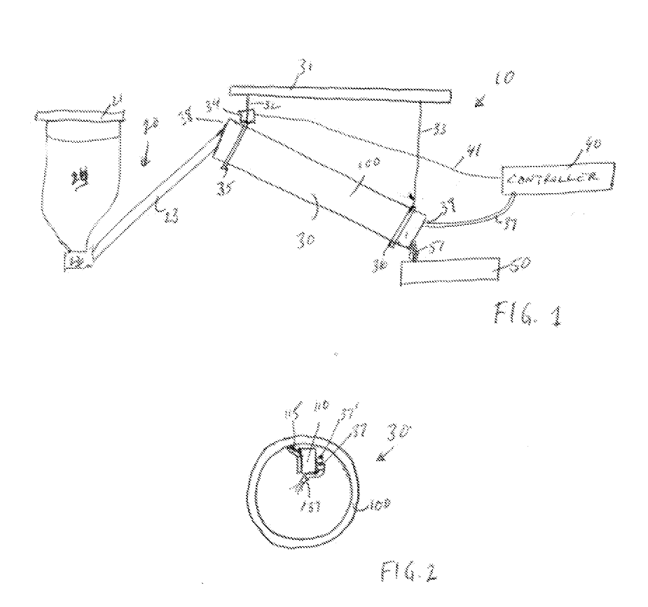

FIG. 1 illustrates a continuous feed mixer 10 according to an embodiment of the present invention. The mixer 10 includes a solids feed structure 20, a mixing tube 30 and a controller 40. The solids feed structure 20 advances the powered solids or aggregate into a feed end 38 of the mixing tube 30. A liquid for the mixture is fed into the mixing tube 30 through a liquid tube 37 from the controller 40. The powered solids or aggregate are mixed with the liquid within the mixing tube 30. The mixing tube 30 is angled downwardly from the feed end 38 to an exit end 39. Gravity causes the powered solids or aggregate to move along the tube while being mixed with the liquid. The final mixture 51 discharges from the exit end 39 of the mixing tube 30. A catch basin 50 receives the mixture for use. The catch basin 50 may be of any time to receive the mixture, either for future processing or to receive the mixture. When used with cement, the catch basin 50 may be mold for a cement structure.

FIG. 2 is a cross sectional view of a mixing tube 30 according to an embodiment of the present invention. The mixing tube 30 includes a cylindrical tube 100 forming a periphery of the mixing tube and forming a mixing chamber. The cylindrical tube 100 rotates about its central axis. Different mechanisms can be used to rotate the cylindrical tube. According to an embodiment of the invention, a pair of rings 35, 36 are positioned around the cylindrical tube 100 towards opposing ends. The rings 35, 36 function to allow the tube 100 to rotate within the rings 35, 36. A motor 34 is connected to one of the rings 35 to cause rotation. The motor 34 is connected to the controller 40 by a control wire 41. The controller 40 provides electrical power or other type of signal to the motor 34 to cause rotation of the tube 100 and to control the speed of rotation.

An elongated scraper 110 is positioned within the cylindrical tube 100 towards an upper end. The scraper 110 extends along the entire length of the cylindrical tube 100. The scraper 110 is connected to the structure of the mixer so that it does not move while the cylindrical tube 100 rotates. This can be accomplished by extending the scraper from one or both ends of the cylindrical tube 100. The scraper 110 includes a blade 115 which is positioned against an inner wall of the cylindrical tube 100. As the tube 100 rotates, the blade 115 of the scraper 110 removes any solids, aggregate and/or mixture from the inner wall of the tube 1 00. The material removed from the inner wall falls to a lower part of the tube 100.

One or more tubes 37, 37′ are positioned along a side of the scraper 110 away from the blade 115. The tubes 37, 37′ extend from the controller 40 and provide a conduit for the liquid to be added to the mixer. Each tube 37, 37′ ends in a nozzle 137 for dispensing the liquid. Other mechanisms can also be used to distribute liquid. For example, each tube 37, 37′ could include multiple holes along its length within the cylindrical tube to distribute liquid at various locations along the length.

A support structure 31 is positioned above the mixer to support the mixing tube 30. Support lines 32, 33 extend from the support structure 31 to the mixing tube 30 to hold it up. The support structure may be a ceiling of a building in which the mixer is installed. A moveable support structure may also be used. Alternatively, a support structure may be positioned below the mixer to hold up the mixing tube rather than the mixing tube hanging from the support structure. Preferably, the support structure 31 and/or support lines 32, 33 are adjustable so that the angle of inclination of the mixing tube can be changed. The adjustable nature of the support structure 31 may be automatic, manual, and/or controlled by the controller 40.

The solids feed structure 20 is used to provide the powered solids or aggregate to the feed end 38 of the mixing tube in a substantially continuous manner. Conventional structures can be used. As illustrated in FIG. 1, the powered solids may disposed in a silo 24. The silo 24 is supported by a support structure 21, which may be of any known type. As is known in the cement industry, the powered cement can be obtained in silo bags for automatic feeding. A feed box 22 is positioned under the silo 24 to receive the solid from the silo 24. The feed box 22 is connected to a feed ramp 23. The feed ramp 23 may be a conveyor belt, screw auger, or other structure, as are known in the art, for feeding the solids to the feed end 38 of the mixing tube 30 in a controlled manner. The feed ramp 23 may be controlled by the controller 40 or may be controlled separately.

The controller 40 operates to control the proportions of solids and liquid mixed in the mixer 10 and the rate of mixing. Preferably, the controller 40 is connected to the motor 34 to control the rate of rotation of the mixing tube 30. The controller 40 is also connected to the liquid tubes 37 for controlling the rate of deposition of liquid within the mixing tube 30. When multiple liquid tubes 37, 37′ are used, the controller may control each one separately so that different amounts of liquid are deposited at different locations within the mixing tube 30.

For operation of the mixer 10, the motor 34 is engaged to begin rotation of the mixing tube 30. The feed ramp 23 is also engaged to begin feeding the powered solids into the feed end 38 of the mixing tube. Once the powered solids reach the feed end of the mixing tube 30, liquid is added through the liquid tubes 37, 37′ into the mixing tube 30 to be combined with the solids. The solids and liquid are mixed through rotation of the mixing tube 30, which will cause the mixture to tumble. If the mixture becomes sticky or thickens, it may stick to the walls of the mixing tube 30. If the mixture sticks to the walls of the mixing tube 30, it is removed by the blade 115 of the scraper 110. When removed, the mixture falls to a lower portion of the mixing tube 30 so that it continues to be combined. Since the mixing tube 30 is angled, the mixture moves along the length of the mixing tube 30 during the mixing process. The amount of mixing depends upon the rate of rotation of the mixing tube 30 and the inclination. Different mixtures may require different rates or inclinations to properly mix the ingredients.

Cleaning the mixing tube can be easily accomplished through use of the liquid tubes 37, 37′. Once all of a mixture has been removed from the mixing tube 30 under ordinary mixing conditions, water or a cleaning solution can be deposited within the mixing tube 30 through the liquid tubes 37, 37′. When mixing cement (and other products), water is the liquid used. The liquid tubes 37, 37′ are just turned back on to provide more water within the mixing tube 30. For other types of liquids, the source for the liquid tubes 37, 37′ may need to be changed for the cleaning operation. The mixing tube 30 continues to rotate during cleaning. The water to cleaning solution is spread throughout the mixing tube 30 and excess material is scraped from the interior wall. The excess liquid and debris are flushed from the mixing tube 30 out the exit end 39.

Having disclosed at least one embodiment of the present invention, various adaptations, modifications, additions, and improvements will be readily apparent to those of ordinary skill in the art. Such adaptations, modifications, additions and improvements are considered part of the invention which is only limited by the several claims attached hereto.

1. A continuous feed mixer for mixing solids with a liquid comprising:
a mixing tube having a first end at a first height for receiving the solids and a second end at a second height lower than the first height;
a motor connected to the mixing tube for rotating the mixing tube along its longitudinal axis; and
tubing disposed within an interior of the mixing tube dispensing the liquid at at least one location within the mixing tube.

2. The continuous feed mixer according to claim 1 further comprising:
an elongated scraper contacting an upper, interior surface of the mixing tube along at least a portion thereof.

3. The continuous feed mixer according to claim 2 wherein the elongated scraper extends along an entire length of the mixing tube.

4. The continuous feed mixer according to claim 1 wherein the tubing extends along a length of the mixing tube and has a plurality of apertures for dispensing liquid at a plurality of locations within the mixing tube.

5. The continuous feed mixer according to claim 1 further comprising a controller connected to the motor for adjusting a rate of rotation of the mixing tube.

6. The continuous feed mixer according to claim 1 further comprising a controller connected to the tubing for adjusting a rate of dispensing of the liquid.

7. The continuous feed mixer according to claim 1 further comprising a feeder for inputting solids at the first end of the mixing tube.

8. The continuous feed mixer according to claim 7 further comprising a controller connected to the feeder for controlling a rate at which solids are input into the mixing tube.

9. The continuous feed mixer according to claim 1 further comprising a support for holding the mixing tube.

10. The continuous feed mixer according to claim 9 wherein the support is adjustable such that at least one of the first height and the second height can be changed.

11. The continuous feed mixer according to claim 1 wherein the solids are cement solids.
